(19) United States
(12) Patent Application Publication
(10) Pub. No.: US 2019/0005974 A1
(43) Pub. Date: Jan. 3, 2019

(54) ALIGNMENT OF BI-DIRECTIONAL MULTI-STREAM MULTI-RATE I2S AUDIO TRANSMITTED BETWEEN INTEGRATED CIRCUITS

(71) Applicant: QUALCOMM Incorporated, San Diego, CA (US)

(72) Inventors: Magesh HARIHARAN, San Diego, CA (US); Stefan ROHRER, Simonswald (DE); Ren LI, San Diego, CA (US); Matthew SIENKO, San Diego, CA (US); Arash MEHRABI, San Diego, CA (US); Ye HU, San Diego, CA (US); Stefan MUELLER, Freiburg (DE)

(21) Appl. No.: 15/635,553

(22) Filed: Jun. 28, 2017

(51) Int. Cl. G10L 19/16; H04J 3/02; H04J 3/22; G10L 19/008

(52) U.S. Cl. CPC G10L 19/167; G10L 19/008; H04J 3/22; H04J 3/02

(57) ABSTRACT

System, methods and apparatus are described that relate to aligning timing of bi-directional, multi-stream I2S audio transmitted between IC devices, and to support audio streams that are digitized using multiple sampling rates. A method includes time-division multiplexing a first stream of digitized audio data with a second stream of digitized audio data at a primary device to obtain a first multiplexed signal, transmitting the first multiplexed signal over a serial bus to a secondary device is configured to extract the first stream of digitized audio data from the first multiplexed signal and provide the first stream of digitized audio data to a first audio peripheral coupled to the secondary device, extracting the second stream of digitized audio data from the first multiplexed signal at the primary device, and providing the extracted second stream of digitized audio data to a second audio peripheral coupled to the first device

### TECHNICAL FIELD

At least one aspect generally relates to data communications interfaces, and more particularly, to data communications interfaces used to connect devices in audio, visual or multimedia systems.

### BACKGROUND

Electronic devices, including mobile communication devices, wearable computing devices such as smartwatches, and tablet computers support ever increasing functionalities and capabilities. Many electronic devices include internal microphones and speakers and may include connectors that enable the use of audiovisual equipment including headphones, external speakers, and the like, internal and external microphones and speakers used in electronic devices have traditionally been connected through analog interfaces. In one example, a mobile phone may include a two port connector that supports stereo headphones. Demand for increased audiovisual capabilities continues to grow. For example, mobile communications devices may include video cameras and stereo microphones, which may he modified over time to improve performance. In another example, digital processing capabilities may permit an electronic device to implement sound decoders that can provide signals to drive more than two speakers. In these and other examples, improved communications capabilities are needed to enable processing circuits, controllers, coder-decoder (Codec) devices and other components to transmit audio data to multiple audio devices over a common communications bus.

### SUMMARY

Certain aspects disclosed herein relate to timing in a communication interface using a protocol such as the Inter-IC Sound (I2S or I²S) protocol. Certain aspects disclosed herein relate to systems and methods for aligning timing of bi-directional, multi-stream I2S audio transmitted between IC devices, and to support audio streams that are digitized using multiple sampling rates.

In various aspects of the disclosure, a method includes time-division multiplexing a first stream of digitized audio data with a second stream of digitized audio data at a primary device to obtain a first multiplexed signal, transmitting the first multiplexed signal over a serial bus to a secondary device configured to extract the first stream of digitized audio data from the first multiplexed signal and provide the first stream of digitized audio data to a first audio peripheral coupled to the secondary device, extracting the second stream of digitized audio data from the first multiplexed signal at the primary device, and providing the extracted second stream of digitized audio data to a second audio peripheral coupled to the first device.

In some aspects, the first stream of digitized audio data may be multiplexed with the second stream of digitized audio data using a first I2S interface circuit. The first I2S interface circuit may be configured to serialize the first stream of digitized audio data, serialize the second stream of digitized audio data, and interleave serialized words of the first stream of digitized audio data with serialized words of the second stream of digitized audio data. Extracting the second stream of digitized audio data from the first multiplexed signal includes providing a feedback signal representative of the first multiplexed signal to the first I2S interface circuit. The first I2S interface circuit may de-interleave serialized data corresponding to the second stream of digitized audio data from the feedback signal and de-serialize the serialized data corresponding to the second stream of digitized audio data. The secondary device may be configured to extract the first stream of digitized audio data from the first multiplexed signal using a second I2S interface circuit. A sample rate converter may be used to modify a sampling rate associated with the first stream of digitized audio data provided to the first I2S interface circuit or the second stream of digitized audio data provided to the first I2S interface circuit.

In one aspect, a sample rate converter may be used to modify a sampling rate associated with a stream of digitized audio data provided to the first audio peripheral or the second audio peripheral. The first audio peripheral and the second audio peripheral may include digital-to-analog converters configured to produce analog signals from respective digitized audio data.

In certain aspects, a third I2S interface circuit may be used to provide a second multiplexed signal by time-division multiplexing a third stream of digitized audio data generated by a third audio peripheral coupled to the first device. The second multiplexed signal may he merged with a third multiplexed signal received from the serial bus to obtain a merged multiplexed signal. The third multiplexed signal may include a fourth stream of digitized audio data generated by a fourth audio peripheral coupled to the secondary device, The third I2S interface circuit may extract the third stream of digitized audio data and the fourth stream of digitized audio data from the merged multiplexed signal. Merging the second multiplexed signal with a third multiplexed signal may include using the third I2S interface circuit to interleave serialized words of the third stream of digitized audio data with serialized words of the fourth stream of digitized audio data, The third audio peripheral and the fourth audio peripheral may include analog-to-digital converters configured to produce digitized audio data from analog signals, A sample rate converter may be used to modify a sampling rate associated with the third stream of digitized audio data extracted from the merged multiplexed signal or the fourth stream of digitized audio data extracted from the merged multiplexed signal. A sample rate converter may be used to modify a sampling rate associated with a stream of digitized audio data provided to the third audio peripheral or the fourth audio peripheral.

In various aspects of the disclosure, an apparatus includes a first device coupled to an I2S bus. The first device may include a first I2S interface coupled to a plurality of wires of an I2S bus. The first I2S interface may be configured to time-division multiplex a first stream of digitized audio data with a second stream of digitized audio data to obtain a first multiplexed signal, transmit the first multiplexed signal over the I2S bus to the second device, receive a feedback signal representative of the first multiplexed signal, extract the first stream of digitized audio data from the feedback signal, and provide the first stream of digitized audio data extracted from the feedback signal to a second audio peripheral coupled to the primary device. The apparatus includes a second device coupled to the I2S bus. The second device includes a second I2S interface configured to extract the second stream of digitized audio data from the first multiplexed signal and provide the second stream of digitized audio data to a first audio peripheral coupled to the second device.

In certain aspects, the first I2S interface is configured to serialize the first stream of digitized audio data, serialize the second stream of digitized audio data, and interleave serialized words of the first stream of digitized audio data with serialized words of the second stream of digitized audio data to obtain the first multiplexed signal. The first I2S interface may be configured to de-interleave serialized data corresponding to the first stream of digitized audio data from the feedback signal, and de-serialize, the serialized data corresponding to the first stream of digitized audio data.

The apparatus may include a sample rate converter coupled to the first I2S interface and configured to provide the first stream of digitized audio data provided to the first I2S interface or the second stream of digitized audio data provided to the first I2S interface. The sample rate converter may be configured to modify a sample rate of one or more source audio signals.

In some aspects, the apparatus includes a sample rate converter coupled to the first I2S interface and configured to modify a sampling rate associated with a stream of digitized audio data provided to the first audio peripheral or the second audio peripheral. The first audio peripheral and the second audio peripheral may include digital-to-analog converters configured to produce analog signals from respective digitized audio data.

In certain aspects, the first device includes a third I2S interface configured to time-division multiplex a third stream of digitized audio data generated by a third audio peripheral coupled to the primary device to provide a second multiplexed signal, merge the second multiplexed signal with a third multiplexed signal received from the I2S bus to obtain a merged multiplexed signal, the third multiplexed signal comprising a fourth stream of digitized audio data generated by a fourth audio peripheral coupled to the second device, and extract the third stream of digitized audio data and the fourth stream of digitized audio data from the merged multiplexed signal. The third I2S interface may be configured to interleave serialized words of the third stream of digitized audio data. with serialized words of the fourth stream of digitized audio data to obtain the merged multiplexed signal. The third audio peripheral and the fourth audio peripheral may include analog-to-digital converters configured to produce digitized audio data from analog signals. The apparatus may include a sample rate converter configured to provide the third stream of digitized audio data to the second I2S interface. The sample rate converter may be configured to modify a sample rate of one or more source audio signals.

In various aspects of the disclosure, an apparatus includes means for time-division multiplexing a first stream of digitized audio data with a second stream of digitized audio data to obtain a first multiplexed signal, means for transmitting the first multiplexed signal over a serial bus to a secondary device that is configured to extract the first stream of digitized audio data from the first multiplexed signal and provide the first stream of digitized audio data to a first audio peripheral coupled to the secondary device, and means for extracting the second stream of digitized audio data from the first multiplexed signal. The means for extracting the second stream of digitized audio data may be configured to provide the second stream of digitized audio data is provided to a second audio peripheral coupled to the primary device.

In some aspects, the means for time-division multiplexing the first stream of digitized audio data is configured to serialize the first stream of digitized audio data, serialize the second stream of digitized audio data, and interleave serialized words of the first stream of digitized audio data with serialized words of the second stream of digitized audio data. The means for modifying a sampling rate associated with the first stream of digitized audio data or the second stream of digitized audio data.

In one aspect, the apparatus includes means for providing a second multiplexed signal by time-division multiplexing a third stream of digitized audio data generated by a third audio peripheral coupled to the primary device, means for merging the second multiplexed signal with a third multiplexed signal received from the serial bus to obtain a merged multiplexed signal, the third multiplexed signal comprising a fourth stream of digitized audio data generated by a fourth audio peripheral coupled to the secondary device, and means for extracting the third stream of digitized audio data and the fourth stream of digitized audio data from the merged multiplexed signal.

In various aspects of the disclosure, a processor-readable medium is configured to store processor-executable code. The code may be executable by a processor, controller and/or computer. When executing the code, a processor may cause a primary device to time-division multiplex a first stream of digitized audio data with a second stream of digitized audio data to obtain a first multiplexed signal, transmit the first multiplexed signal over a serial bus to a secondary device that is configured to extract the first stream of digitized audio data from the first multiplexed signal and provide the first stream of digitized audio data to a first audio peripheral coupled to the secondary device, cause the primary device to extract the second stream of digitized audio data from the first multiplexed signal, and provide the second stream of digitized audio data extracted from the first multiplexed signal to a second audio peripheral coupled to the primary device.

The processor-readable medium may include code for causing a processor to serialize the first stream of digitized audio data, serialize the second stream of digitized audio data, and interleave serialized words of the first stream of digitized audio data with serialized words of the second stream of digitized audio data.

The processor-readable may include code for causing a processor to provide a feedback signal representative of the first multiplexed signal, and may cause the primary device to de-interleave serialized data corresponding to the second stream of digitized audio data from the feedback signal, and de-serialize the serialized data corresponding to the second stream of digitized audio data.

The processor-readable may include code for causing a processor to cause the primary device to provide a second multiplexed signal by time-division multiplexing a third stream of digitized audio data generated by a third audio peripheral coupled to the primary device, merge the second multiplexed signal with a third multiplexed signal received from the serial bus to obtain a merged multiplexed signal, the third multiplexed signal comprising a fourth stream of digitized audio data generated by a fourth audio peripheral coupled to the secondary device, and cause the primary device to extract the third stream of digitized audio data and the fourth stream of digitized audio data from the merged multiplexed signal.

### BRIEF DESCRIPTION OF THE DRAWINGS

FIG. 1 depicts an apparatus employing a data link between integrated circuit (IC) devices that may be adapted in accordance with certain aspects disclosed herein.

FIG. 2 illustrates a system that illustrates communication of audio data through an I2S bus.

FIG. 3 illustrates transmission of bi-directional, multi-stream, multi-rate I2S audio data may be transmitted over an I2S bus.

FIG. 4 illustrates a first example of a system adapted to provide matched transmission paths for different audio data streams in accordance with certain aspects disclosed herein.

FIG. 5 illustrates timing associated with the system illustrated in FIG. 4.

FIG. 6 illustrates a second example of a system adapted to provide matched transmission paths for different audio data streams in accordance with certain aspects disclosed herein.

FIG. 7 illustrates a third example of a system adapted to match transmission paths where sample rate matching for different audio data streams is provided in accordance with certain aspects disclosed herein.

FIG. 8 illustrates a fourth example of a system adapted to match transmission paths where sample rate matching for different audio data streams is provided in accordance with certain aspects disclosed herein.

FIG. 9 is a diagram illustrating an example of an apparatus employing a processing circuit that may be adapted according to certain aspects disclosed herein.

FIG. 10 is a flow chart of a method operational on one of two devices in an apparatus according to certain aspects disclosed herein.

FIG. 11 is a diagram illustrating an example of a hardware implementation for an apparatus employing a processing employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details, in some instances, well-known structures and components are shown in block diagram form in order to avoid obscuring such concepts.

Several aspects of data communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. Examples of processors include microprocessors, microcontrollers, digital signal processors (DSPs), field. programmable gate arrays (FPGAs), programmable logic devices (PLDs), application. specific integrated circuits (ASICs), a system-on-chip (SoC), state machines, gated logic, discrete hardware circuits, and other suitable hardware configured to perform the various functionality described throughout this disclosure.

Overview

Certain aspects disclosed herein relate to systems, apparatus and methods that can reduce or eliminate skew between audio playback and recordings by matching delays encountered by different streams of digitized audio data. In one example, a first audio stream may be sourced and processed in the same IC device, while a second audio stream sourced in the IC device may be transmitted over an I2S bus for processing. The I2S interface can introduce delays affecting only the second audio stream, thereby introducing skew. An I2S interface may be further adapted in accordance with certain aspects disclosed herein to support transmission of audio data when transmitters and receivers are configured for different sample rates.

Example of Mobile Communication Device

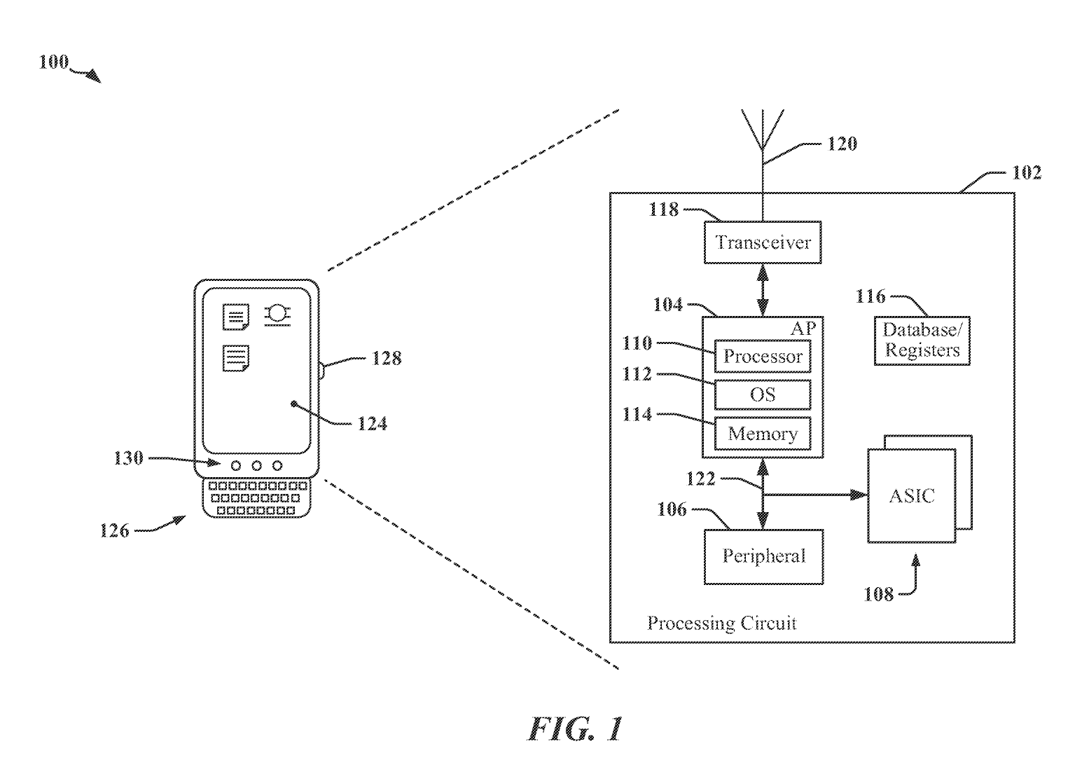

FIG. 1 depicts an apparatus 100 that may employ a communication link deployed within and/or between IC devices. In one example, the apparatus 100 may include a communication device that communicates through a radio frequency (RE) communications transceiver 118 with a radio access network (RAN), a core access network, the Internet and/or another network. The communications transceiver 118 may be embodied in, or operably coupled to a processing circuit 102. The processing circuit 102 may be implemented using an SoC and/or may one or more IC devices. In one example, the processing circuit 102 may include one or more application processors 104, one or more ASICs 108, and one or more peripheral devices 106 such as Codecs, amplifiers and other audiovisual components. Each ASIC 108 may include one or more processing devices, logic circuits, storage, registers, and so on. An application processor 104 may include a processor 110 and memory 114, and may be controlled by an operating system 112 that is loaded from internal or external storage as data and instructions that are executable by the processor 110. The processing circuit 102 may include or access a local database 116 implemented in the memory 114, for example, where the database 116 can be used to maintain operational parameters and other information used to configure and operate the apparatus 100. The local database 116 may be implemented as a set of registers, or may be implemented in a database module, flash memory, magnetic media, non-volatile or persistent storage, optical media, tape, soft or hard disk, or the like. The processing circuit may also be operably coupled to external devices such as an antenna 120, a display 124, operator controls, such as buttons 128, 130 and a keypad 126 among other components.

A data bus 122 may be provided to support communication between the application processor 104, ASICs 108 and/or the peripheral devices 106. The data bus 122 may be operated in accordance with standard protocols defined for interconnecting certain components of mobile devices. For example, there are multiple types of interface defined for communications between an application processor and display and camera components of a mobile device, or between an audio processor and a Codec provided in the same or different ASICs 108, or between an audio processor in an ASIC 108 and a Codec or audio driver in one of the peripheral devices 106. In some examples, certain components may be adapted to communicate using a protocol such as the I2S protocol. Some components employ an interface that conforms to standards specified by the Mobile industry Processor Interface (MIPI) Alliance. For example, the MIPI Alliance defines the SLIMbus and SoundWire interface standards that enable designers of mobile devices to achieve design goals including scalability, reduced power, lower pin count, ease of integration, and consistency between system designs.

The classic I2S protocol, for example, define a serial interface that has three or more wires, and that can be used to communicate audio data that has been encoded using pulse-code modulation (PCM). PCM provides a digital representation of sampled analog signals, where a fixed sampling rate is defined or configured and sampled amplitudes of an analog signal are quantized using digital steps I2S protocols. In one example, an analog audio signal may be sampled using an analog-to-digital converter (ADC) to provide a digitized audio signal. The analog audio signal may he provided by a microphone, recording device, storage, or other source of analog audio signals. The digitized audio signal may be processed using a digital signal processor or other processor configured to perform filtering, error correction, analysis, storage, or other functions, and/or to compress and/or store the digitized audio signal, In another example, a digital signal processor may generate or otherwise provide a digitized audio signal (e.g., retrieved from storage) to a digital to analog converter (DAC), which outputs an analog audio signal that can be provided to a loudspeaker, amplifier, etc.

Overview of the I2S Protocol

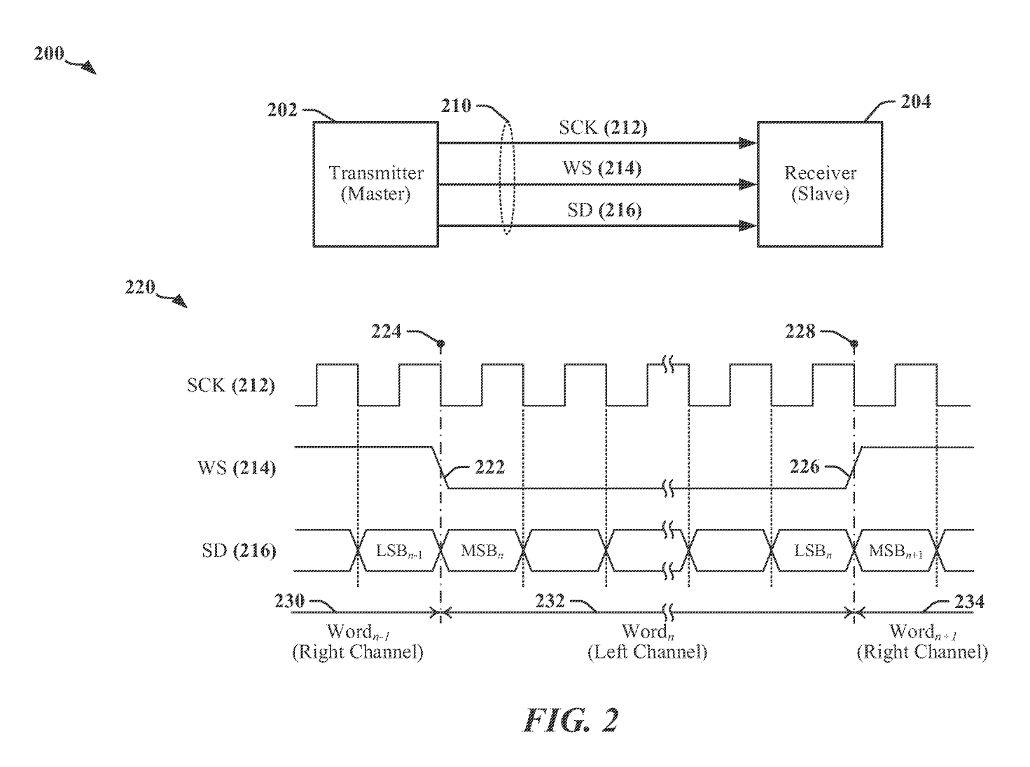

FIG. 2 illustrates a system 200 that provides for unidirectional communication of PCM data through an I2S bus 210. In the illustrated example, the I2S bus 210 couples a transmitter 202 provided in a first IC device to a receiver 204 provided in a second IC device. The transmitter 202 serves as a bus master and generates a continuous serial clock signal (SCK 212) and a word select signal (WS 214) in addition to audio data transmitted in the serial data signal (SD 216). In other implementations, the receiver 204 may serve as the bus master and may generate SCK 212 and WS 214 in addition to receiving audio data from SD 216.

The I2S protocol enables two streams of audio data to be transmitted on SD 216. For the purposes of his description, the two streams may be referred to as right stream and left stream. The right stream may carry a digitized audio signal to be used to drive a first loudspeaker (Right Speaker), while the left stream may carry a digitized audio signal to be used to drive a second loudspeaker (Left Speaker). Right stream data words and left stream data words are alternated on the I2S bus 210,

The timing diagram 220 in FIG. 2 illustrates transmission of right stream words and left stream words. In one example, right stream words are transmitted on SD 216 when WS 214 is high and left stream words are transmitted on SD 216 when WS 214 is low. As illustrated, a failing edge 222 occurring in WS 214 at a time that corresponds to a boundary 224 between a first right stream word 230 and a left stream word 232. A rising edge 226 occurring in WS 214 at a time that corresponds to a boundary 228 between the left stream word 232 and a second right stream word 234.

In the timing diagram 220, the edges 222, 226 in WS 214 are depicted as being coincident with the boundaries 224, 228 between consecutively transmitted words 230, 232, 234. In some instances, I2S transmitters 202 and/or receivers 204 devices may include buffers, registers, flip-flops and/or other circuits that delay serial transmit data and receive data with respect to WS 214. In one example, the edges 222, 226 in WS 214 may occur before the boundaries 224, 228 between consecutively transmitted serialized words 230 232, 234 output by the transmitter 202 or receiver 204. In some implementations, versions of WS 214 may be generated to control the operation of logic circuits in the transmitter 202 or receiver 204.

The I2S bus 210 may be configured for bidirectional communication between the transmitter 202 and the receiver 204. In bidirectional implementation, a pair of SD wires 216 may be provided to carry data in opposite directions. The transmission of data follows the signaling illustrated in the timing diagram 220 regardless of direction of transmission.

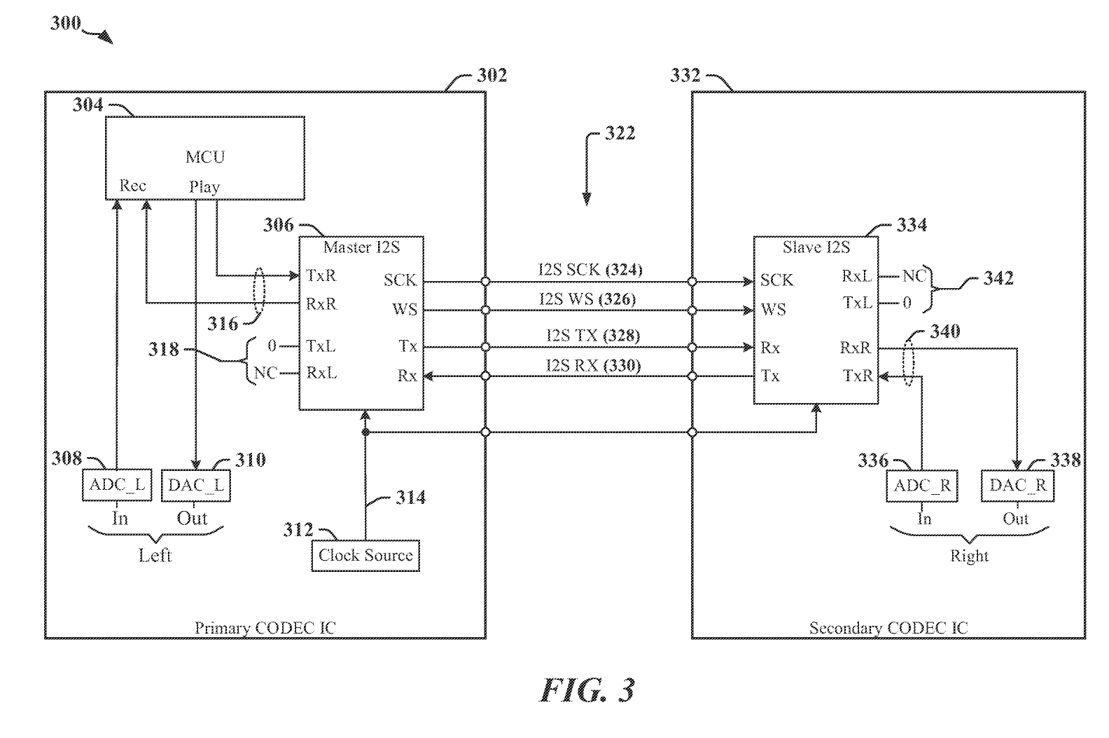

FIG. 3 illustrates a system 300 in which bi-directional, multi-stream, multi-rate I2S audio data may be transmitted over an I2S bus 322 between a pair of IC devices 302, 332. The I2S bus 322 may be configured for bi-directional operation. A first direction, defined as commencing from a primary IC device 302 and continuing to a secondary IC device 332, may he related to playback of audio through one or more loudspeaker, while a second direction, defined as commencing from the secondary IC device 332 and continuing to the primary IC device 302, may be related to recording or processing of audio captured using a microphone.

The I2S bus 322 may be adapted for multi-stream operation, in which data transmitted in each direction includes more than one stream or channel. The example illustrated in FIG. 3 may relate to a stereo implementation that provides a left stream and a right stream. More than two streams may be supported using I2S bus implementations. For example, a 5.1 playback mode supports 6 audio streams for a corresponding 6 loudspeakers.

The I2S bus 322 may support multi-rate applications, in which analog audio signals may be sampled at various sampling rates (sampling frequencies). The data transmitted over the I2S bus 322 may include data representative of analog signals sampled at one of a plurality of configurable sampling frequencies.

In the illustrated example, both IC devices 302, 332 may operate as audio Codecs. The primary IC device 302 hosts a processing entity that may include a microcontroller (MCU 304) or other type of processor or processing circuit. The MCU 304 can be a source and/or sink of audio data. The MCU 304 may act as a conduit for exchanging digitized audio data with another host IC device through an interface such as the universal serial bus (USB) etc.

Digitized audio data sourced by the MCU 304 can include more than one stream. In the illustrated example, two streams are illustrated in a stereo implementation. The digitized audio data sourced by the MCU 304 typically can have a relatively high sampling rate, such as 96 kHz, 192 kHz, 384 kHz, etc., Digitized audio data received at the MCU 304 can include more than one stream. In the illustrated example, two streams are illustrated in a stereo implementation. The digitized audio data received by the MCU 304 typically has a relatively lower sampling rate, such as 48 kHz, 32 kHz, 16 kHz, 8 kHz etc.

The primary IC device 302 may include one or more clock sources 312 that may he used to control and/or synchronize the timing of signals transmitted on the I2S bus 322. One or more signals 314 may be provided to I2S interface devices 306, 334 in the primary IC device 302 and/or the secondary IC device 332.

The primary IC device 302 may include one or more ADC, including the left ADC 308, and one or more DAC, including the left DAC 310. The primary IC device 302 may use the left ADC 308 to digitize audio signals obtained from a left-side microphone or other transducer, and may use the left DAC 310 to drive a left-side speaker. In some instances, a right-side microphone and right-side speaker may be handled by the secondary IC device 332. In one example, the primary IC device 302 may have insufficient ADCs and DACs to handle the right-side microphone and right-side speaker. In another example, the secondary IC device 332 may be configured to handle the right-side microphone and right-side speaker for reasons related to physical location, and/or application requirements. In the example, the primary IC device 302 consumes one stream of multi-stream audio data sourced by the MCU 304, and produces one stream of the multi-stream audio data received by the MCU 304.

The primary IC device 302 includes an I2S interface device 306 that may be configured to operate as a master device that produces the serial clock and word select signals that are transmitted on the I2S bus 322 as I2S SCK 324 and I2S WS 326 respectively. The I2S interface device 306 may communicate right-side streams 316 between the MCU 304 and the secondary IC device 332. The left-side streams are not communicated over the I2S bus 322 and corresponding input/output 318 to the I2S interface device 306 may be unconnected and/or tied to voltage level corresponding to a logic ‘0’ state or logic ‘1’ state. In this configuration, the I2S interface device 306 transmits and receives digitized. audio data corresponding to the right-side stream when indicated by I2S WS 326. One or more of I2S TX 328 and I2S 330 may be idle when I2S WS 326 indicates left-side transmission.

The secondary IC device 332 may include one or more ADC, including the right-side ADC 336, and one or more DAC, including the right-side DAC 338. The secondary IC device 332 may use the right-side ADC 336 to digitize audio signals obtained from a right-side microphone or other transducer, and may use the right-side DAC 338 to drive a right-side speaker, in the example, the secondary IC device 332 consumes one stream of multi-stream audio data that is sourced by the MCU 304 and communicated over the I2S bus 322. The secondary IC device 332 produces one stream of multi-stream audio data for transmission over the I2S bus 322 to the MCU 304.

The secondary IC device 332 includes an I2S interface device 334 that may be configured to operate as a slave device that receives the serial clock and word select signals from the I2S bus 322 as I2S SCK 324 and I2S WS 326 respectively. The I2S interface device 334 may communicate right-side streams 340 between the secondary IC device 332 and the MCU 304 of the primary IC device 302 through the I2S bus 322. The left-side streams are not transmitted over the I2S bus 322 and corresponding input/output 342 to the I2S interface device 334 may be unconnected and/or tied to voltage level corresponding to a logic ‘0’ state or logic ‘1’ state.

It is contemplated that the concepts described and disclosed herein can apply to interfaces adapted for transporting more than two audio data streams, including where the audio data streams are encoded using time-division multiplexing (TDM) similar to the TDM employed in I2S interfaces.

In playback operations, audio streams produced by the MCU 304 are directed to the DACs 310, 338 and corresponding speakers in the respective IC devices 302, 332. The audio streams produced by MCU 304 are typically related. For example, the audio streams may relate to left and right channel audio, or 5.1 audio. The audio streams are to he played in synchronism by IC devices 302, 332, such that the first sample in the audio streams drive respective speakers at the same time. Typically, the audio streams produced by the MCU 304 are digitized using the same sampling rate.

In recording operations, audio streams consumed by the MCU 304 are sourced from microphone inputs through ADCs 308, 336 in respective IC devices 302, 332. The audio streams consumed by the MCU 304 typically have a temporal relation. In one example, audio inputs are obtained during binaural recording. The audio sampled by microphones coupled to the IC devices 302, 332 are expected to be aligned when received at the MCU 304. Typically, the audio streams consumed by the MCU 304 are digitized using the same sampling rate.

Alignment of I2S Audio Streams

Synchronism may be lost or compromised when related digital audio streams are processed by different IC devices 302, 332. During playback, the right-side DAC 338 the secondary IC device 332 processes right-side audio samples received from the MCU through the I2S bus 322, while left-side audio samples from the MCU 304 are processed by the left-side DAC 310 that is collocated with the MCU 304 on the primary IC device 302. Latencies introduced by the I2S interface devices 306, 334 cause samples in different streams with the same time-stamp to arrive at their respective DACs 310, 338 at different times. In the example illustrated in FIG. 3, left-side samples can arrive at the left-side DAC 310 before right-side samples arrive at the right-side DAC 338, causing out-of-synchronism playback, During Recording audio samples from the right-side ADC 336 are communicated over the I2S bus 322 to the MCU 304, while left-side audio samples produced by the left-side ADC 308 are communicated directly to the collocated MCU 304 (on the primary IC device 302). Latencies introduced by the I2S interface devices 306, 334 can cause samples captured at the same time by the ADCs 308, 336 to be skewed in time when they reach the MCU 304. In the example illustrated in FIG. 3, left-side samples can arrive at the MCU 304 before right-side samples.

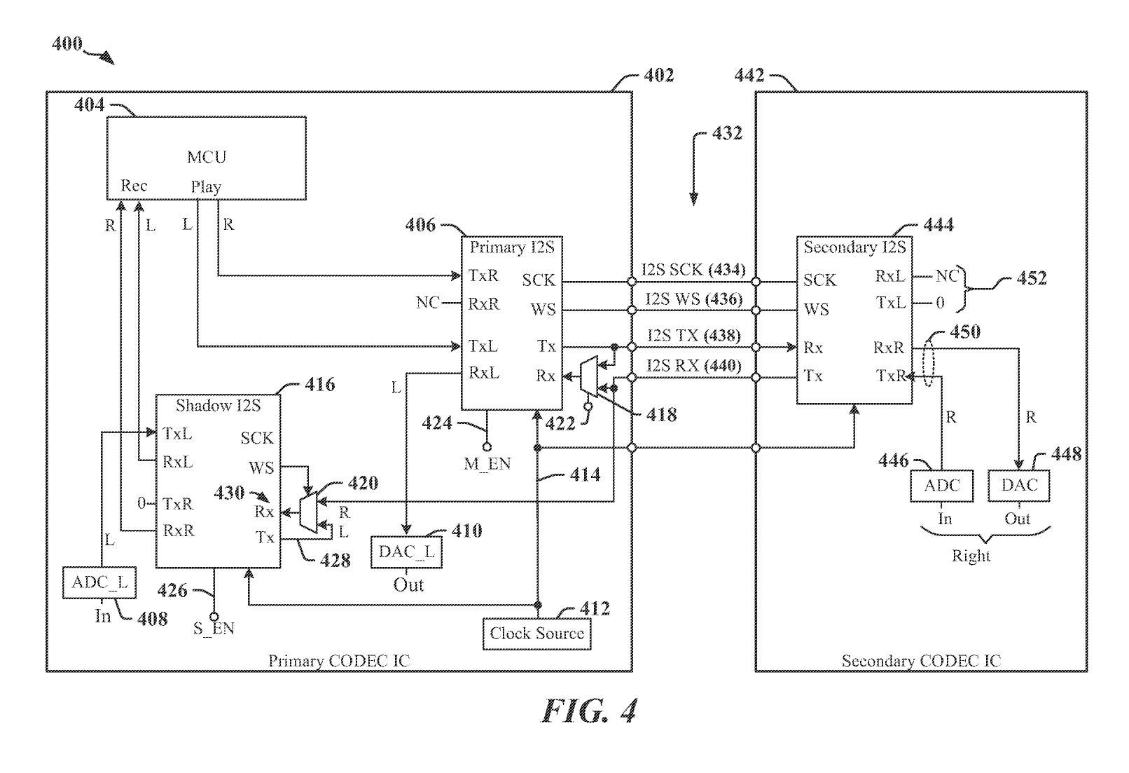

Certain aspects disclosed herein relate to apparatus and methods that can reduce or eliminate skew between data streams by matching delays encountered by different streams of digitized audio data. FIG. 4 illustrates a first example of a system 400 adapted in accordance with certain aspects to provide matched transmission paths for different audio data streams in which one or more streams are transmitted over an I2S bus 432 between a pair of IC devices 402, 442, while one or more streams are processed within one IC device 402. The I2S bus 432 may be configured for bi-directional operation. A first direction, defined from a primary IC device 402 to a secondary IC device 442, may be related to playback of audio through one or more loudspeaker, while a second direction, defined from the secondary IC device 442 to the primary IC device 402, may be related to recording or processing of audio captured using a microphone.

The I2S bus 432 may be adapted for multi-stream operation, in which data transmitted in each direction includes more than one stream or channel. The example system 400 illustrated in FIG. 4 may relate to a stereo implementation that provides a left stream and a right stream. More than two streams may be supported using I2S bus implementations. For example, a 5.1 playback mode supports 6 audio streams for a corresponding 6 loudspeakers. Certain aspects disclosed herein can be seamlessly extended to provide a TDM, I2S-like structure that supports multiple audio channels,

In the illustrated system 400, the primary IC device 402 handles left-side audio while the secondary IC device 442 handles right-side audio. In other implementations, the primary IC device 402 may be adapted to handle right-side audio while the secondary IC device 442 may be adapted to handle left-side audio. In other implementations, left-side playback and right-side recording may be handled by a first IC device 402, 442 while right-side playback and left-side recording is handled by a second IC device 442, 402.

The I2S bus 432 may support multi-rate applications, in which analog audio signals may be sampled at various sampling rates (sampling frequencies). The data transmitted over the I2S bus 432 may include data representative of analog signals sampled at one of a plurality of configurable sampling frequencies.

In the illustrated example, both IC devices 402, 442 may operate as audio Codecs. The primary IC device 402 hosts a processing entity that may include a microcontroller (MCU 404) and/or other type of processor or processing circuit. In one example, the MCU 404 can include a direct memory access (DMA) engine (not shown) that may be coupled to, or part of the MCU 404. The MCU 404 can be a source and/or a sink for audio data. The MCU 404 may act as a conduit for exchanging digitized audio data with another device. In one example, the MCU 404 may be configured to relay audio data between the IC devices 402, 442 and a host device through an interface such as the universal serial bus (USB), SLIMbus, or Soundwire etc. The MCU 404 may be coupled to memory or other storage through a standard processor bus, and the MCU 404 may be configured to transmit data to, and/or receive data from one or more locations in the memory or other storage.

Digitized audio data sourced by the MCU 404 can include more than one stream. In the illustrated example, two streams are illustrated in a stereo implementation. The digitized audio data sourced by the MCU 404 typically can have a relatively high sampling rate, such as 96 kHz, 192 kHz, 384 kHz, etc. The digitized audio data received by the MCU 404 typically has a relatively lower sampling rate, such as 48 kHz, 2 kHz, 16 kHz 8 kHz etc.

The primary IC device 402 includes a first I2S interface device that is coupled to the I2S bus 432, and which may be referred to as the primary I2S interface device 406. The primary IC device 402 includes a second I2S interface device that may be referred to as the shadow I2S interface device 416. The secondary IC device 442 includes a third I2S interface device that may be referred to as the secondary I2S interface device 444.

The primary IC device 402 may include a clock source 412 that produces timing signals used to control and/or synchronize the timing of signals transmitted on the I2S bus 432. In one example, pulses transmitted in a signal 414 provided by the clock source 412 may be provided to synchronize or otherwise control operations of the primary I2S interface device 406, the secondary I2S interface device 444, and/or the shadow I2S interface device 416. Each of the primary I2S interface device 406, the secondary I2S interface device 444, and the shadow I2S interface device 416 has a set of parallel interfaces. Left-side and right-side digitized audio data presented in parallel form to TxL and TxR inputs of the I2S interface devices 406, 416, 444 are serialized and multiplexed to produce a signal at a Tx output that can he transmitted over an I2S bus 432. I2S-formatted serial data received at an Rx input may be de-multiplexed and de-serialized to provide digitized audio data presented in parallel form at RxL and RxR outputs of the I2S interface devices 406, 416, 444.

The primary IC device 402 may include one or more ADC, including the left-side ADC 408, and one or more DAC, including the left-side DAC 410. The primary IC device 402 may use the left-side ADC 408 to digitize audio signals obtained from a left-side microphone or other transducer, and may use the left-side DAC 410 to drive a left-side speaker. In some instances, a right-side microphone and right-side speaker may be handled by the secondary IC device 442. In the example illustrated in FIG. 4, the primary IC device 402 consumes one stream of multi-stream audio data sourced by the MCU 404, and produces one stream of the multi-stream audio data received by the MCU 404.

The primary I2S interface device 406 or the secondary I2S interface device 444 may be configured to operate as a master device that produces the serial clock and word select signals that are transmitted on the I2S bus 432 as I2S SCK 434 and I2S WS 436, respectively. The selection of the master device may be based on design requirements, device capabilities and/or for other reasons.

In the example illustrated in FIG. 4, the shadow I2S interface device 416 may be configured to operate as a master device, producing serial clock and word select signals for its internal use and to control external circuits such as a multiplexer 420. The primary I2S interface device 406 and the shadow I2S interface device 416 may be synchronized with the primary I2S interface device 406. One or more signals 414 provided by the clock source 412 may be configured to control timing of respective serial clock and word select signals, and/or to configure or set sampling rates. Reset and/or enable signals 424, 426 may be provided by the MCU 404 or by another processor to synchronize and initialize the primary I2S interface device 406 and the shadow I2S interface device 416, in some instances, the reset and/or enable signals 424, 426 may be tied together.

The secondary IC device 442 may have one or more ADCs, including the right-side ADC 446, and one or more DACs, including the right-side DAC 448. The secondary IC device 442 may use the right-side ADC 446 to digitize audio signals obtained from a right-side microphone or other transducer, and may use the right-side DAC 448 to drive a right-side speaker. In the example, the secondary IC device 442 consumes one stream of multi-stream audio data that is sourced by the MCU 404 and communicated over the I2S bus 432. The secondary IC device 442 produces one stream of multi-stream audio data for transmission over the I2S bus 432 to the MCU 404.

In one example, the secondary interface device 444 may be configured to operate as a slave device that receives the serial clock and word select signals from the I2S SCK 434 and I2S WS 436 signals received from the I2S bus 432. In another example, the secondary interface device 444 may be configured to operate as a master device that provides the serial clock and word select signals to the I2S bus 432 as I2S SCK 434 and I2S WS 436, respectively. The secondary I2S interface device 444 may exchange right-side streams 450 with the MCU 404 through the I2S bus 432. The left-side streams are not transmitted over the I2S bus 322 and corresponding input/output 452 to the secondary I2S interface device 444 may he unconnected and/or tied to voltage level corresponding to a logic ‘0’ state or logic ‘1’ state.

In operation, the primary its interface device 406 may transmit a right-side stream directed to the right-side DAC 448 in accordance with normal I2S procedures. That is, I2S TX 438 carries digitized audio data sourced by the MCU 404 when right-side stream transmission is indicated by US WS 436. The secondary IC device 442 transmits a right-side stream directed to the MCU 404 on 125 RX 440 in accordance with normal I2S procedures. That is, I2S RX 440 carries digitized audio data produced by the right-side ADC 446 when right-side stream transmission is indicated by I2S WS 436. The signal transmitted on I2S RX 440 is redirected to the shadow I2S interface device 416.

The signal received from I2S RX 440 is provided to an input of a multiplexer 420. The output of the multiplexer is selected by the word select signal generated by the shadow I2S interface device 416, and the multiplexer 420 is configured such that the signal received from I2S RX 440 is relayed to the Rx serial input 430 of the shadow I2S interface device 416 when the shadow I2S interface device 416 is expecting right-side data. Accordingly, the shadow I2S interface device 416 extracts the digitized audio data produced by the nigh side ADC 446 and provides the digitized audio data produced by the right-side ADC 446 to the MCU 404. In this configuration, extraction of the digitized audio data produced by the right-side ADC 446 is performed by the shadow I2S interface device 416 in place of the primary US interface device 406.

Digitized audio data produced by the left-side ADC 408 is also processed by the shadow I2S interface device 416. The output of the left-side ADC 408 is provided to the transmit left channel input (TxL) of the shadow I2S interface device 416. When left-side stream transmission is indicated by I2S WS 436, the digitized audio data produced by the left-side ADC 408 channel is transmitted on the transmit (Tx) output 428 of the shadow I2S interface device 416. The Tx output 428 of the shadow I2S interface device 416 is provided as a feedback signal through the multiplexer 420. The multiplexer 420 is configured such that the Tx output 428 of the shadow I2S interface device 416 is relayed to the Rx serial input 430 of the shadow I2S interface device 416 when the shadow I2S interface device 416 is expecting left-side data. Accordingly, the shadow I2S interface device 416 extracts the digitized audio data produced by the left-side ADC 408 and produced by the right-side ADC 446 and delivers the left-side and right-side digitized audio data to the MCU 404.

In some instances, the I2S interface devices 406, 416, 444 may pipeline transmit and receive data. In one example, a pipeline in the transmitter of an I2S interface device 406, 416, 444 may have a depth of one or two words such that data arriving at the TxR and TxL inputs of the I2S interface devices 406 416, 444 may be queued in a pipeline and may be appear ta the Tx output of the I2S interface devices 406, 416, 444 after a one or two-word delay. In some instances, the output of serialization may be buffered or delayed such that edges in I2S WS 436 may occur in advance of the serialized words. Data received from the I2S bus 432 may be further delayed before appearing at the RxR and/or RxL outputs of an I2S interface device 406, 416, 444. The primary IC device 402 and/or the secondary IC device 442 may include circuits that align or optimize timing of various signals.

In some implementations, the output of the multiplexer 420 may be selected using a.

delayed version of I2S WS 436 to meet timing tolerances for the shadow I2S interface device 416, the multiplexer 420, and/or other circuits. In some instances, the delayed version of I2S WS 436 may account for the impact of buffering and/or pipelines on timing of signals used in the transmitter and/or receiver of one or more I2S interface devices 406, 416, 444. In one example, the multiplexer 420 may receive, as a select input, a version of I2S WS 436 that is time-delayed by half a cycle or so to meet timing closure in certain implementations.

According to certain aspects disclosed herein, delay matching is accomplished when digitized audio data produced by the right-side ADC 446 and the left-side ADC 408 are processed in the same manner and traverse similar paths. The digitized audio data obtained from the left-side ADC 408 passes through the shadow I2S interface device 416 and is accordingly subject to the timing that affects the digitized audio data produced by the right-side ADC 446.

Left-side digitized audio data sourced by the MCU 404 is provided indirectly to the left-side DAC 410, The left-side digitized audio data is provided as the left transmit input (TxL) of the primary I2S interface device 406. The left-side digitized audio data is multiplexed with right-side digitized audio data in accordance with the word select signal and transmitted as I2S TX 438, The word select signal is transmitted as I2S WS 436. A signal representative of I2S TX 438 is fed back to the receive input of the Primary I2S interface device 406. in some instances, the feedback path includes a multiplexer 418 configurable using a select signal 422 to select between the feedback signal (i.e., I2S TX 438) and a signal received from the I2S RX 440, The Primary I2S interface device 406 extracts the left-side digitized audio data signal and provides it to the left-side DAC 410. The multiplexer 418 may disable a feedback configuration when the system 400 is operated in a conventional manner, such that right-side data received from I2S RX 440 is processed through the primary I2S interface device 406.

Delay matching is accomplished when digitized audio data received by the right-side DAC 448 and the left-side DAC 410 are processed in the same manner and traverse similar paths. The digitized audio data received by the left-side DAC 410 passes through the primary I2S interface device 406 and is accordingly subject to the timing that affects the digitized audio data transmitted to the right-side DAC 448.

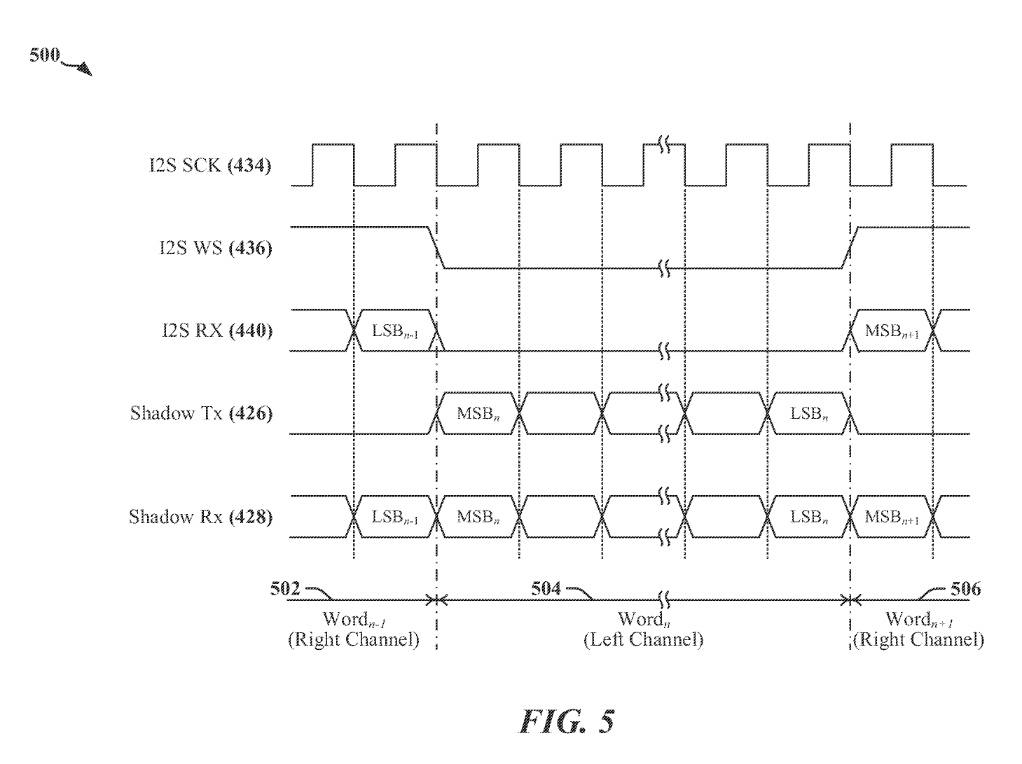

FIG. 5 is a timing diagram 500 that illustrates the processing of digitized audio data produced by the left-side ADC 408 and the right-side ADC 446. Right-side audio data produced by the right-side ADC 446 is received as right-side serial words 502, 506 from I2S RX 440 when I2S WS 436 is high. In the example of the system 400 illustrated in FIG. 4, I2S RX 440 is low when I2S WS 436 is low. When I2S WS 436 is high, the multiplexer 420 provides the right-side serial words 502, 506 to the Rx serial input 430 of the shadow I2S interface device 416.

When I2S WS 436 is low, left-side audio data produced by the left-side ADC 408 is received and serialized at the left channel input (TxL) of the shadow I2S interface device 416. The shadow I2S interface device 416 serializes the audio data word produced by the left-side ADC 408 and provides a left-side word 504 at the Tx output 428 of the shadow I2S interface device 416 when I2S WS 436 is low. When I2S WS 436 is low, the multiplexer 420 provides the left-side word 504 to the Rx serial input 430 of the shadow US interface device 416.

The Rx serial input 430 of the shadow I2S interface device 416 receives a serial data stream that is formatted according to I2S protocols and that includes left-side and right-side audio data. The shadow I2S interface device 416 de-serializes the serial data stream and provides parallel right-side and left-side audio data to the MCU 404.

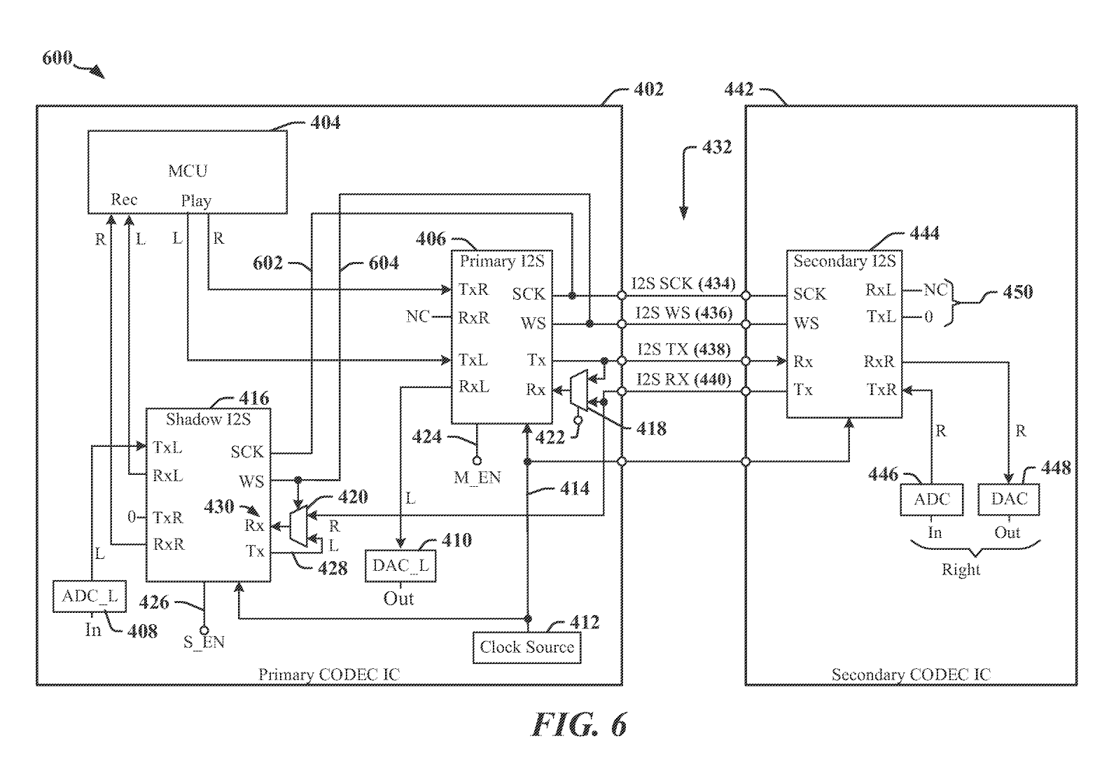

FIG. 6 illustrates a second example of a system 600 adapted in accordance with certain aspects to provide matched transmission paths for different audio data streams. The system 600 operates in similar fashion to the system 400 illustrated in FIG. 4. In the system 600 of FIG. 6, the shadow I2S interface device 416 is coupled to a serial clock signal 602 and a word select signal 604 representative of the signals transmitted on the I2S bus 432 as I2S SCK 434 and I2S WS 436, respectively, In one example, the shadow I2S interface device 416 may be configured to operate as a slave device, and the shadow I2S interface device 416 may be configured to use the serial clock signal 602 and word select signal 604 produced by the primary I2S interface device 406 or the secondary I2S interface device 444. In some implementations, the primary I2S interface device 406 and the shadow I2S interface device 416 may be synchronized with the primary I2S interface device 406 and may use a sampling rate pulse or clock signal in a signal 414 provided by a clock source 412, where the clock signal may control timing of respective serial clock and word select signals. Reset and/or enable signals 424, 426 may be used by a processor to synchronize and initialize the primary I2S interface device 406 and the shadow I2S interface device 416.

The primary I2S interface device 406 or the secondary I2S interface device 444 may be configured to operate as a master device that produces the serial clock and word select signals that are transmitted on the I2S bus 432 as I2S SCK 434 and I2S WS 436 respectively. The selection of the master device may be based on design requirements, device capabilities and/or any other reason. In some implementations, the shadow I2S interface device 416 may he configured to operate as a master device that produces the serial clock signal 602 and word select signal 604 that may be transmitted on the I2S bus 432 as I2S SCK 434 and I2S WS 436, respectively, In the latter implementations, the primary I2S interface device 406 and the secondary I2S interface device 444 can be configured to operate as slave devices.

Multi-Rate I2S Audio Streams

In conventional systems, audio data transmitted over I2S interfaces is generated using fixed PCM sampling rates, and transmitted over the I2S bus using a fixed I2S bit clock frequency. In conventional I2S interfaces, both the receiver and the transmitter are configured for the same sampling rate. Digital representations of sampled analog signals are obtained at a sampling rate defined or configured for the interface. Amplitudes of the analog signals are quantized using digital steps defined by I2S protocols.

In conventional systems, support for different sample rates using an I2S bus necessitates using an additional I2S interface for each additional sampling rate. Each additional I2S interface uses four additional pins and/or wires on a circuit board, chip carrier, or other substrate on which the IC devices are mounted.

An I2S interface adapted in accordance with certain aspects disclosed herein can support transmission of audio data when transmitters and receivers are configured for different sample rates.

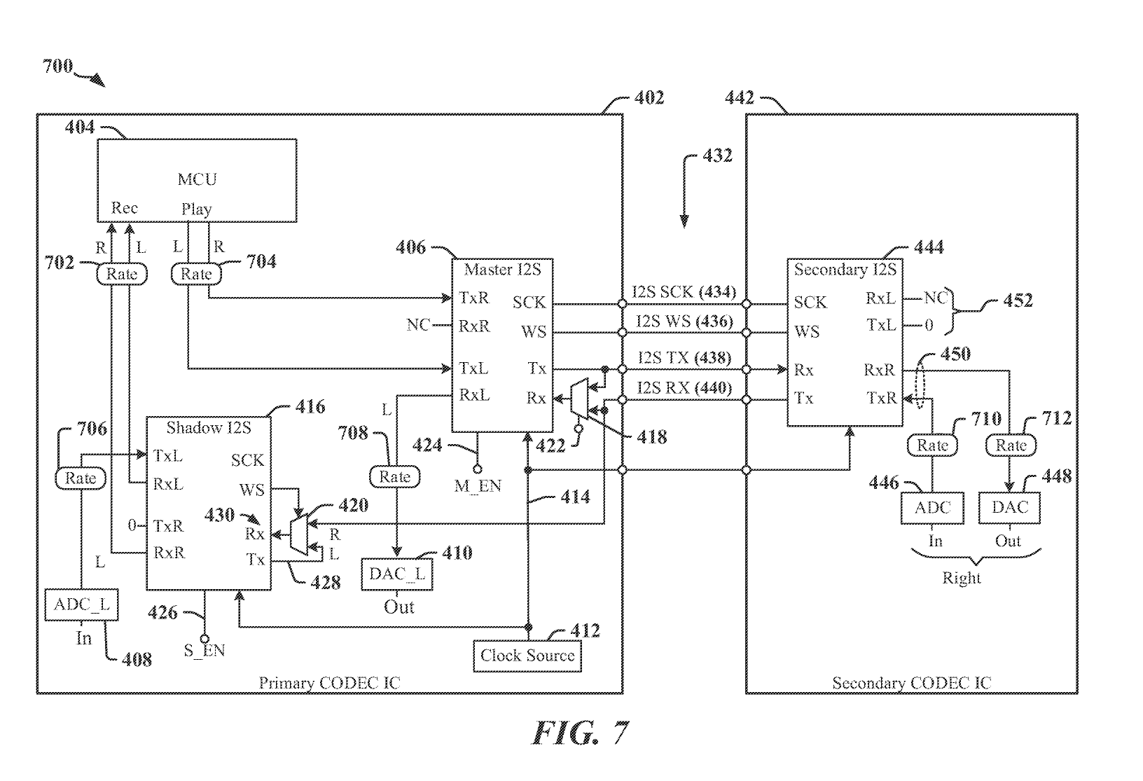

FIG. 7 illustrates a third example of a system 700 adapted in accordance with certain aspects disclosed herein. Additionally, the system 700 may be adapted to support transmission of audio data when transmitters and receivers are configured for different sample rates. The system 700 operates in similar fashion to the system 400 of FIG. 4, where the shadow I2S interface device 416 is configured to operate as an I2S master device. The primary IC device 402 in the system 700 is adapted to include one or more sample rate converters 702, 704, 706, 708 configured to modify the sampling rate of one or more PCM signals in the primary IC device 402. The secondary IC device 442 may be adapted to include one or more sample rate converters 702, 704, 706, 708 configured to modify the sampling rate of one or more PCM signals in the secondary IC device 442.

The interface devices 406, 416 in the primary IC device 402 and the interface device 444 in the secondary IC device 442 may respond to a sampling rate pulse provided in a signal 414 received from a local clock controller or clock source 412. A clock source 412 in the primary IC device 402 may supply the sampling rate pulse for both the primary IC device 402 and the secondary IC device 442, The sampling rate pulse may be used to sample parallel input to be serialized over the interface. The sampling rate pulse may be used to latch the serial data bits received from the interface after conversion to a parallel word.

The system 700 may be adapted according to certain aspects disclosed herein to support different sampling rates for different audio streams. For example, sampling rates for a recording stream can be lower than sampling rate of a playback stream. In one aspect disclosed herein, sampling rate pulses corresponding to the fastest audio stream are provided to all interface devices 406, 416, 444 to support multiple rates for recording and/or playback audio streams. Sample rate converters 702, 704, 706, 708, 710, 712 may be added to playback and/or recording paths to support multi-rate streams.

In a first example of rate conversion, sample rate converters 706, 710 may be provided between ADCs 408, 446 and interface devices 406, 444, respectively, When playback sampling rate is greater than recording sampling rate, interface devices 406, 416, 444 are clocked using a signal 414 that includes pulses provided at the sampling rate corresponding to the faster playback sampling rate. An interface device 406, 416, 444 that receives recording path data from an ADC 408, 446 operating at a lower sampling rate may effectively repeat parallel-to-serial conversion of one recording sample multiple times as needed to match playback sampling rate. In the illustrated example, rate-matching may be accomplished using the sample rate converter 706 inserted between the left-side ADC 408 and the shadow I2S interface device 416 and/or the sample rate converter 710 inserted between the right-side ADC 446 and the secondary I2S interface device 444. The sample rate converters 706, 710 produce rate-adapted parallel data.

In the first example of rate conversion, rate-adapted parallel data is serialized by an interface device 416, 444 at a rate selected to accommodate the faster playback sampling rate, The shadow interface device 416 deserializes the rate-adapted parallel data at the faster playback sampling rate, which is higher than the lower ADC sampling rate. The RxL and RxR outputs of the shadow interface device 416, while clocked at the faster playback sampling, change at the lower ADC sampling rate due to the repetition of recording samples. The repetition is transparent to the MCU 404, which captures multiple copies of the same sample. Sample repeat can be implemented using a simple hold circuit, clock management circuits, etc.

In a second example of rate conversion, the MCU 404 may be configured to receive data at a lower rate than the sample rate of one or more ADC 408, 446. Sample rate converter 702 coupled to the MCU 404 may be configured to drop a proportion of the audio data words directed to the MCU 404. Sample drop can be implemented using a register or memory element that is updated in accordance with the slow sample interval period, for example.

In a third example of rate conversion, the MCU 404 may be configured to source data at a higher rate than the sample, rate configured for the primary I2S interface device 406. The sample rate converter 704 coupled to the MCU 404 may be configured to drop a proportion of the audio data words sourced by the MCU 404. Sample drop can be implemented using a register or memory element that is updated in accordance with the slow sample interval period, for example.

In a fourth example of rate conversion, the MCU 404 may be configured to receive data at a first rate that is lower than the sample rate configured for one or more interface devices 406, 416, 444, and one or more ADC 408, 446 may be configured to receive data at a second rate that is lower than the sample rate configured for one or more interface devices 406, 416, 444. In some instances, the first rate and second rate are the same. Rate-matching between ADCs 408, 446 and interface devices 416, 444 may be accomplished by repeating samples using the sample rate converter 706 inserted between the left-side ADC 408 and the shadow I2S interface device 416 and/or the sample rate converter 710 inserted between the right-side ADC 446 and the secondary I2S interface device 444, Rate-matching between the slave I2S interface device 416 and the MCU 404 may be accomplished by configuring the sample rate converters 702 coupled to the MCU 404 to drop a proportion of the audio data words directed to the MCU 404.

Other rate adaptation configurations may be implemented using some combination of the sample rate converters 702, 704, 706, 708, 710, 712, in certain examples illustrated and discussed herein, sample rate converters 702, 704, 706, 708, 710, 712 employ sample repeat and sample drop techniques. Sample repeat and sample drop operate optimally when the relationship between sampling rates can be represented by an integer scaling factor. For example, the difference between sampling rates of 384 kHz and 48 kHz may he represented by a scaling factor of 8. In some instances, the sample rate converters 702, 704, 706, 708, 710, 712 may he configured to support rate conversion when recording sampling rates exceed playback sampling rates,

According to certain aspects, a resampling sample rate converter can be used in place of sample repeat or sample drop circuits when complex rate conversions are involved. Complex rate conversions may include sampling rates that have a relationship represented by a non-integer scaling factor. Complex rate conversions may also exist when asynchronous data streams are communicated through the I2S interface. In one example, a sample rate converter may convert a PCM signal to a continuous analog signal, and resample the continuous analog signal at a new sampling rate. in another example, a sample rate converter may calculate values of the new samples directly from old samples. In another example, a sample rate converter may perform a combination of sample repeat to create a PCM signal at a higher intermediate sampling rate and perform sample drop to obtain a PCM signal at the desired sampling rate using integer scaling factors for both up-sampling (sample insert) and down-sampling (sample drop).

According to certain aspects, one or more of the sample rate converters 702, 704, 706, 708, 710, 712 may include a sample repeat circuit that operates using zero stuffing. A zero-stuffing sample repeat circuit may operate by inserting a number of zero-value words between samples. A receiving device may be configured to filter or ignore zero-value words and/or to drop words that are expected to be zero-value words, thereby retaining only sampled words.

According to certain aspects, a clock source 412 on the primary IC device 402 generates a signal that includes a sampling pulse train used by each I2S interface device 406, 416. 444. In some instances, each IC device 402, 442 can independently produce sampling pulse trains. For example, the clock source 412 may provide a sampling pulse train to one or more of the I2S interface devices 406, 416 in the primary IC device 402, while a clock circuit (not shown) on the secondary IC device 442 provides a sampling pulse train to the slave I2S interface devices 444 on the secondary IC device 442. When separate sampling pulse trains are generated, a common reference clock may be used for pulse generation. The common reference clock may be provided by the primary IC device 402, the secondary IC device 442 or by another IC device coupled to the primary IC device 402 and the secondary IC device 442.

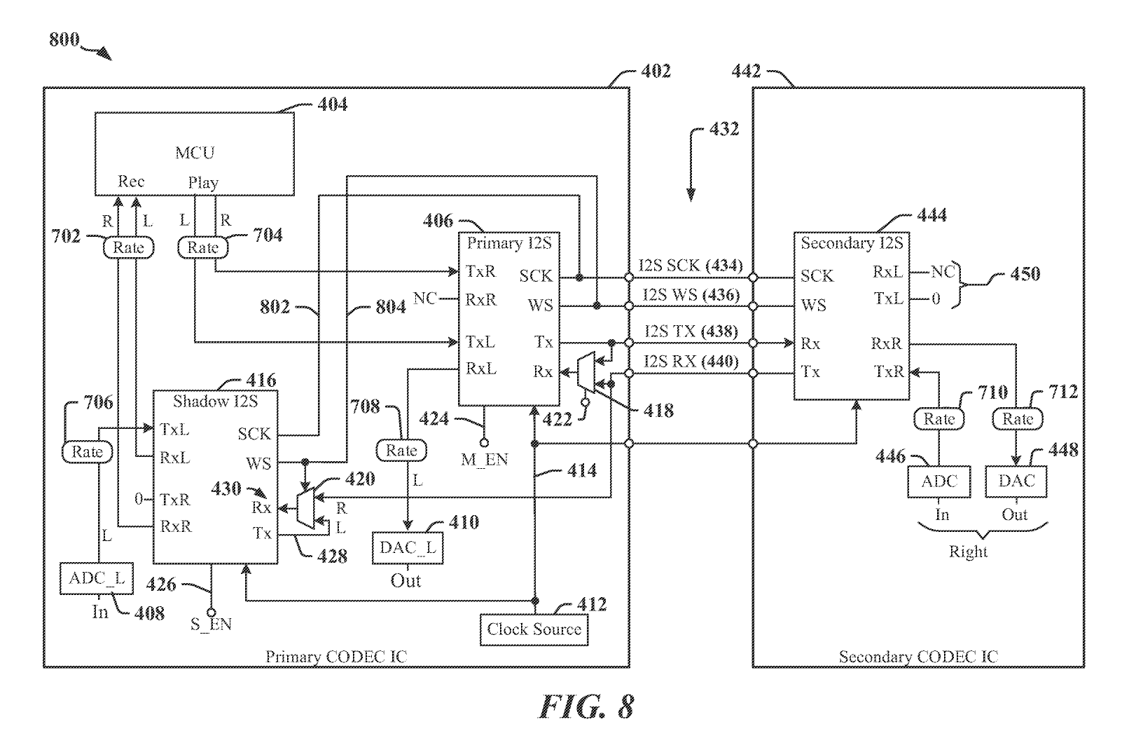

FIG. 8 illustrates a second example of a system 800 adapted in accordance with certain aspects to provide matched transmission paths for different audio data streams. The system 700 communicates audio data in similar fashion to the system 600 of FIG. 6 and provides rate adaptation similar to the rate adaptation provided in the system 700 illustrated in FIG. In the system 800 of FIG. 8, the shadow I2S interface device 416 is coupled to a serial clock signal 802 and a word select signal 804 representative of the signals transmitted on the I2S bus 432 as I2S SCK 434 and I2S WS 436, respectively. In the system 800 illustrated in FIG. 8, the shadow I2S interface device 416 may be configured to operate as a slave device. The shadow I2S interface device 416 may be configured to use the serial clock signal 802 and word select signal 804 produced by the primary I2S interface device 406 or the secondary I2S interface device 444. In one example, the primary I2S interface device 406 and the shadow I2S interface device 416 may be synchronized with the primary I2S interface device 406 and may use a sampling rate pulse or clock signal in a signal 414 provided by a clock source 412, when. the clock signal may control timing of respective serial clock and word select signals. Reset and/or enable signals 424, 426 may be used by a processor to synchronize and initialize the primary I2S interface device 406 and the shadow I2S interface device 416,

The primary I2S interface device 406 or the secondary I2S interface device 444 may be configured to operate as a master device that produces the serial clock and word select signals that are transmitted on the I2S bus 432 as I2S SCK 434 and I2S WS 436 respectively. The selection of the master device may be based on design requirements, device capabilities and/or any other reason. In some implementations, the shadow I2S interface device 416 may be configured to operate as a master device that produces the serial clock signal 802 and word select signal 804 that may be transmitted on the I2S bus 432 as I2S SCK 434 and I2S WS 436, respectively. In the latter implementations, the primary I2S interface device 406 and the secondary I2S interface device 444 can be configured to operate as slave devices.

Additional Descriptions Of Certain Aspects

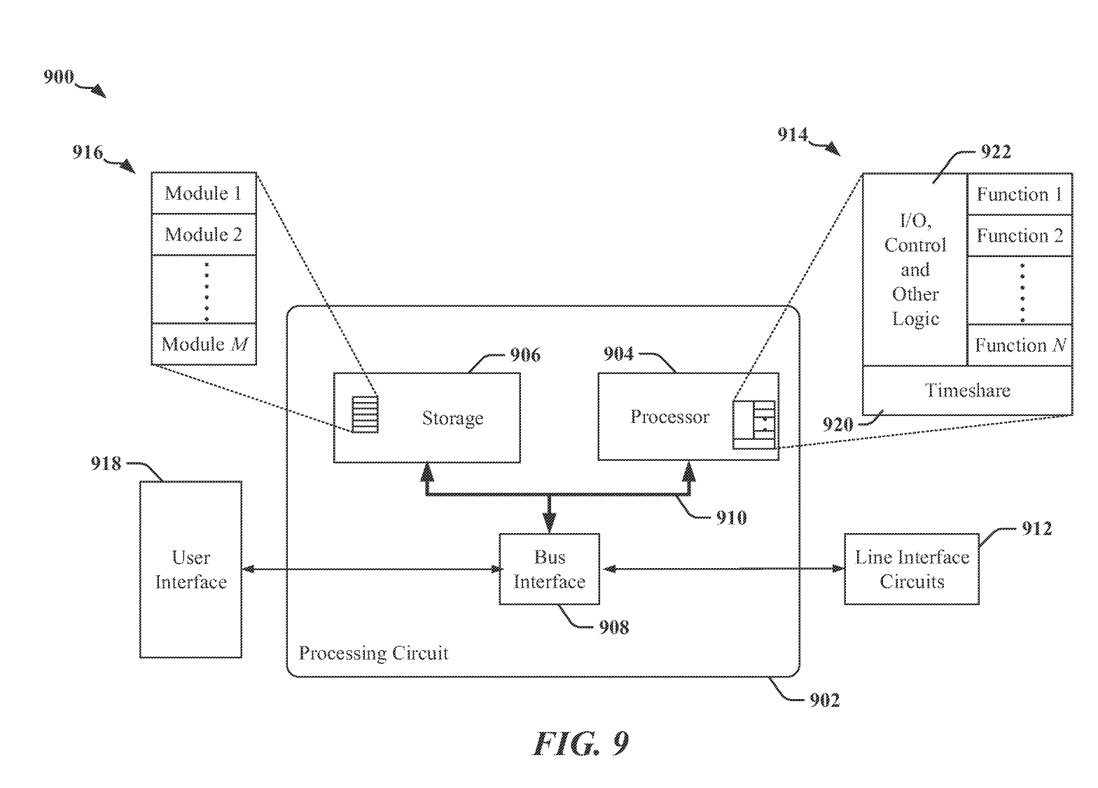

FIG. 9 is a conceptual diagram illustrating a simplified example of a hardware implementation for an apparatus 900 employing a processing circuit 902 that may be configured to perform one or more functions disclosed herein. In accordance with various aspects of the disclosure, an element, or any portion of an element, or any combination of elements as disclosed herein may be implemented using the processing circuit 902. The processing circuit 902 may include one or more processors 904 that are controlled by some combination of hardware and software modules. Examples of processors 904 include microprocessors, microcontrollers, digital signal processors (DSPs), ASICs field programmable gate arrays (FPGAs), programmable logic devices (PLDs), state machines, sequencers, gated logic, discrete hardware circuits, and other suitable hardware configured to perform the various functionality described throughout this disclosure. The one or more processors 904 may include specialized processors that perform specific functions, and that may be configured, augmented or controlled by one of the software modules 916. The one or more processors 904 may he configured through a combination of software modules 916 loaded during initialization, and further configured by loading or unloading one or more software modules 916 during operation.

In the illustrated example, the processing circuit 902 may be implemented with a bus architecture, represented generally by the bus 910. The bus 910 may include any number of interconnecting buses and bridges depending on the specific application of the processing circuit 902 and the overall design constraints. The bus 910 links together various circuits including the one or more processors 904, and storage 906. Storage 906 may include memory devices and mass storage devices, and may be referred to herein as computer-readable media and/or processor-readable media. The bus 910 may also link various other circuits such as timing sources, timers, peripherals, voltage regulators, and power management circuits. A bus interface 908 may provide an interface between the bus 910 and one or more line interface circuits 912. A line interface circuit 912 may be provided for each networking technology supported by the processing circuit. In some instances, multiple networking technologies may share some or all of the circuitry or processing modules found in a line interface circuit 912. Each line interface circuit 912 provides a means for communicating with various other apparatus over a transmission medium. Depending upon the nature of the apparatus, a user interface 918 (e.g., keypad, display, speaker, microphone, joystick) may also be provided, and may be communicatively coupled to the bus 910 directly or through the bus interface 908.

A processor 904 may be responsible for managing the bus 910 and for general processing that may include the execution of software stored in a computer-readable medium that may include the storage 906. In this respect, the processing circuit 902, including the processor 904, may be used to implement any of the methods, functions and techniques disclosed herein. The storage 906 may be used for storing data that is manipulated by the processor 904 when executing software, and the software may be configured to implement any one of the methods disclosed herein.

One or more processors 904 in the processing circuit 902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 906 or in an external computer readable medium. The external computer-readable medium and/or storage 906 may include a non-transitory computer-readable medium. A non--transitory computer-readable medium includes, by way of example, a magnetic storage device (e.g., hard disk, floppy disk, magnetic strip), an optical disk (e.g., a compact disc (CD) or a digital versatile disc (MID)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer, The computer-readable medium and/or storage 906 may also include, by way of example, a carrier wave, a transmission line, and any other suitable medium for transmitting software and/or instructions that may be accessed and read by a computer. Computer-readable medium and/or the storage 906 may reside in the processing circuit 902, in the processor 904, external to the processing circuit 902, or be distributed across multiple entities including the processing circuit 902. The computer-readable medium and/or storage 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 906 may maintain software maintained and/or organized in loadable code segments, modules, applications, programs, etc., which may be referred to herein as software modules 916. Each of the software modules 916 may include instructions and data that, when installed or loaded on the processing circuit 902 and executed by the one or more processors 904, contribute to a run-time image 914 that controls the operation of the one or more processors 904. When executed, certain instructions may cause the processing circuit 902 to perform functions in accordance with certain methods, algorithms and processes described herein.

Some of the software modules 916 may be loaded during initialization of the processing circuit 902, and these software modules 916 may configure the processing circuit 902 to enable performance of the various functions disclosed herein. For example, some software modules 916 may configure internal devices and/or logic circuits 922 of the processor 904, and may manage access to external devices such as the line interface circuit 912, the bus interface 908, the user interface 918, timers, mathematical coprocessors, and so on. The software modules 916 may include a control program and/or an operating system that interacts with interrupt handlers and device drivers, and that controls access to various resources provided by the processing circuit 902. The resources may include memory, processing time, access to the line interface circuit 912, the user interface 918, and so on.

One or more processors 904 of the processing circuit 902 may be multifunctional, whereby some of the software modules 916 are loaded and configured to perform different functions or different instances of the same function. The one or more processors 904 may additionally be adapted to manage background tasks initiated in response to inputs from the user interface 918, the line interface circuit 912, and device drivers, for example. To support the performance of multiple functions, the one or more processors 904 may be configured to provide a multitasking environment, whereby each of a plurality of functions is implemented as a set of tasks serviced by the one or more processors 904 as needed or desired. In one example, the multitasking environment may be implemented using a timesharing program 920 that passes control of a processor 904 between different tasks, whereby each task returns control of the one or more processors 904 to the timesharing program 920 upon completion of any outstanding operations and/or in response to an input such as an interrupt. When a task has control of the one or more processors 904, the processing circuit is effectively specialized for the purposes addressed by the function associated with the controlling task. The timesharing program 920 may include an operating system, a main loop that transfers control on a round-robin basis, a function that allocates control of the one or more processors 904 in accordance with a prioritization of the functions, and/or an interrupt driven main loop that responds to external events by providing control of the one or more processors 904 to a handling function.

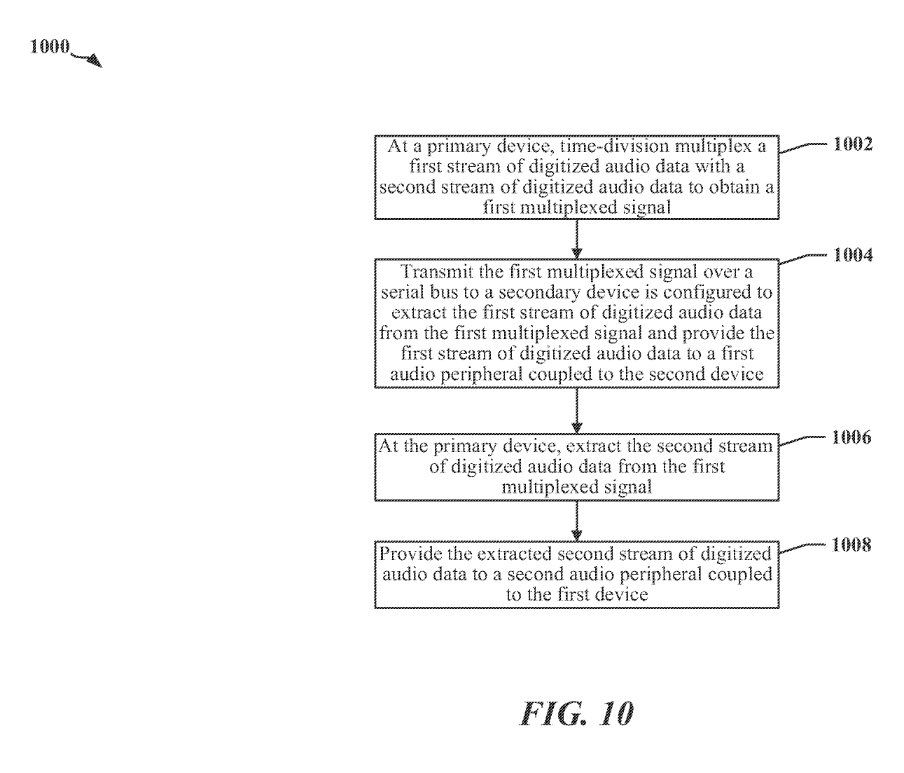

FIG. 10 is a flow chart 1000 of a method operational a first IC device (primary device) coupled to second IC device (secondary device).

At block 1002, the primary device may time-division multiplex a first stream of digitized audio data with a second stream of digitized audio data to obtain a first multiplexed signal. Time-division multiplexing the first stream of digitized audio data. with the second stream of digitized audio data may be performed at a first I2S interface circuit. The first I2S interface circuit may he configured to serialize the first stream of digitized audio data, serialize the second stream of digitized audio data, and interleave serialized words of the first stream of digitized audio data with serialized words of the second stream of digitized audio data.

At block 1004, the primary device may transmit the first multiplexed signal over a serial bus to a secondary device. The secondary device may be configured to extract the first stream of digitized audio data from the first multiplexed signal and provide the first stream of digitized audio data to a first audio peripheral coupled to the second device.

At block 1006, the primary device may extract the second stream of digitized audio data from the first multiplexed signal. The second stream of digitized audio data may be extracted from the first multiplexed signal by providing a feedback signal representative of the first multiplexed signal to the first I2S interface circuit that de-interleaves serialized data corresponding to the second stream of digitized audio data from the feedback signal, and de-serializes the serialized data corresponding to the second stream of digitized audio data.

At block 1008, the primary device may provide the extracted second stream of digitized audio data to a second audio peripheral coupled to the first device.

In one example, the secondary device is configured to extract the first stream of digitized audio data from the first multiplexed signal using a second I2S interface circuit.

In various examples, a sample rate converter may be used to modify a sampling rate associated with the first stream of digitized audio data provided to the first I2S interface circuit or the second stream of digitized audio data provided to the first I2S interface circuit. A sample rate converter may be used to modify a sampling rate associated with a stream of digitized audio data provided to the first audio peripheral or the second audio peripheral. The first audio peripheral and the second audio peripheral may include digital-to-analog converters configured to produce analog signals from respective digitized audio data.

In certain examples, a third I2S interface circuit may be used to provide a second multiplexed signal by time-division multiplexing a third stream of digitized audio data generated by a third audio peripheral coupled to the first device. The second multiplexed signal may be merged with a third multiplexed signal received from the serial bus, thereby providing a merged multiplexed signal, The third multiplexed signal may include a fourth stream of digitized audio data generated by a fourth audio peripheral coupled to the second device. The third I2S interface circuit may extract the third stream of digitized audio data and the fourth stream of digitized audio data from the merged multiplexed signal. The second multiplexed signal. may be merged with the third multiplexed signal at the third I2S interface circuit by interleaving serialized words of the third stream of digitized audio data with serialized words of the fourth stream of digitized audio data.

In some examples, the third audio peripheral and the fourth audio peripheral include analog-to-digital converters configured to produce digitized audio data from analog signals. A sample rate converter may be used to modify a sampling rate associated with the third stream of digitized audio data extracted from the merged multiplexed signal or the fourth stream of digitized audio data extracted from the merged multiplexed signal. A sample rate converter may be used to modify a sampling rate associated with a stream of digitized audio data provided to the third audio peripheral or the fourth audio peripheral.

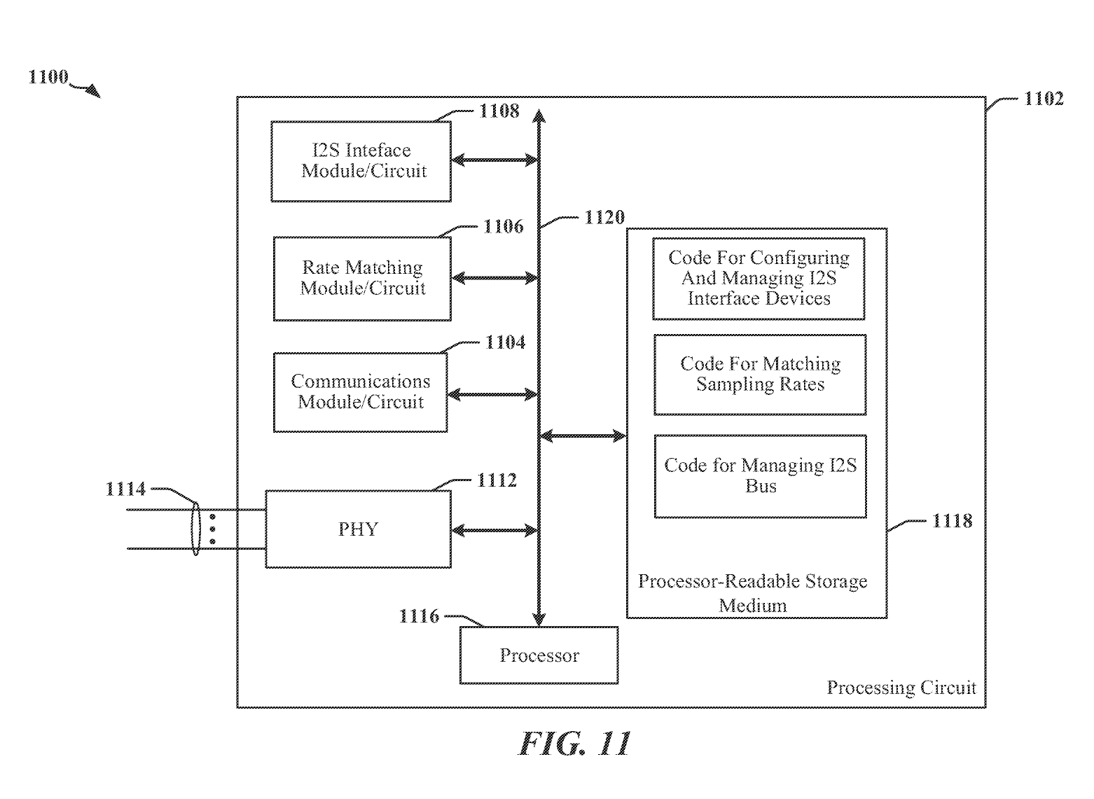

FIG. 11 illustrates an example of a hardware implementation for an apparatus 1100 employing a processing circuit 1102. The processing circuit typically has a processor 1116 that may include one or more of a microprocessor, microcontroller, digital signal processor, a sequencer and a state machine. The processing circuit 1102 may be implemented with a bus architecture, represented generally by the bus 1120. The bus 1120 may include any number of interconnecting buses and bridges depending on the specific application of the processing circuit 1102 and the overall design constraints. The bus 1120 links together various circuits including one or more processors and/or hardware modules, represented by the processor 1116, the modules or circuits 1104, 1106, 1108, and 1108, a physical interface PHY 1112) configurable to communicate over connectors or wires of a multi-wire communication link 1114 and the computer-readable storage medium 1118. The bus 1120 may also link various other circuits such as timing sources, peripherals, voltage regulators, and power management circuits.

The processor 1116 is responsible for general processing, including the execution of software stored on the computer-readable storage medium 1118. The software, when executed by the processor 1116, causes the processing circuit 1102 to perform the various functions described supra for any particular apparatus. The computer-readable storage medium 1118 may also be used for storing data that is manipulated by the processor 1116 when executing software, including data decoded from symbols transmitted over the communication link 1114, which may be configured as data lanes and clock lanes. The processing circuit 1102 further includes at least one of the modules 1104, 1106, 1108, and 1108. The modules 1104, 1106, 1108, and 1108 may be software modules running in the processor 1116, resident/stored in the computer-readable storage medium 1118, one or more hardware modules coupled to the processor 1116, or some combination thereof. The 1104, 1106, 1108, and/or 1108 may include microcontroller instructions, state machine configuration parameters, or some combination thereof.

In one configuration, the PITY 1112 is coupled to a multi-wire communication link 1114. The apparatus 1100 may include a module and/or circuit 1108 configured to time-division multiplex a first stream of digitized audio data with a second stream of digitized audio data to obtain a first multiplexed signal, a module and/or circuit 1104 configured to transmit the first multiplexed signal over a serial bus to a secondary device and a module and/or circuit 1104 configured to match sampling rates for a plurality of digitized audio data streams.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the fill scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to he known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to he construed as a means plus function unless the element is expressly recited using the phrase “means for.”

1. A method, comprising:
at a primary device, time-division multiplexing a first stream of digitized audio data with a second stream of digitized audio data to obtain a first multiplexed signal;
transmitting the first multiplexed signal over a serial bus to a secondary device that is configured to extract the first stream of digitized audio data from the first multiplexed signal and provide the first stream of digitized audio data to a first audio peripheral coupled to the secondary device;
at the primary device, extracting the second stream of digitized audio data from the first multiplexed signal to provide an extracted second stream of digitized audio data; and
providing the extracted second stream of digitized audio data to a second audio peripheral coupled to the primary device,
wherein the first audio peripheral and the second audio peripheral include digital-to-analog converters configured to produce analog signals from respective digitized audio data.

2. The method of claim 1, wherein time-division multiplexing the first stream of digitized audio data with the second stream of digitized audio data comprises using a first Inter-IC Sound (I2S) interface circuit to:
serialize the first stream of digitized audio data;
serialize the second stream of digitized audio data; and
interleave serialized words of the first stream of digitized audio data with serialized words of the second stream of digitized audio data.

3. The method of claim 2, wherein extracting the second stream of digitized audio data from the first multiplexed signal comprises:
providing a feedback signal representative of the first multiplexed signal to the first I2S interface circuit; and
causing the first I2S interface circuit to:
de-interleave serialized data corresponding to the second stream of digitized audio data from the feedback signal; and
de-serialize the serialized data corresponding to the second stream of digitized audio data.

4. A method, comprising:
at a primary device, time-division multiplexing a first stream of digitized audio data with a second stream of digitized audio data to obtain a first multiplexed signal, wherein time-division multiplexing the first stream of digitized audio data with the second stream of digitized audio data comprises using a first Inter-IC Sound (I2S) interface circuit to:
serialize the first stream of digitized audio data;
serialize the second stream of digitized audio data; and
interleave serialized words of the first stream of digitized audio data with serialized words of the second stream of digitized audio data;
transmitting the first multiplexed signal over a serial bus to a secondary device that is configured to extract the first stream of digitized audio data from the first multiplexed signal and provide the first stream of digitized audio data to a first audio peripheral coupled to the secondary device;
at the primary device, extracting the second stream of digitized audio data from the first multiplexed signal to provide an extracted second stream of digitized audio data; and
providing the extracted second stream of digitized audio data to a second audio peripheral coupled to the primary device,
wherein the secondary device is configured to extract the first stream of digitized audio data from the first multiplexed signal using a second I2S interface circuit.

5. The method of claim 2, further comprising:
using a sample rate converter to modify a sampling rate associated with the first stream of digitized audio data provided to the first I2S interface circuit or the second stream of digitized audio data provided to the first I2S interface circuit.

6. The method of claim 1, further comprising:
using a sample rate converter to modify a sampling rate associated with a stream of digitized audio data provided to the first audio peripheral or the second audio peripheral.

7. (canceled)

8. The method of claim 1, further comprising:
using a third I2S interface circuit to provide a second multiplexed signal by time-division multiplexing a third stream of digitized audio data generated by a third audio peripheral coupled to the primary device;
merging the second multiplexed signal with a third multiplexed signal received from the serial bus to obtain a merged multiplexed signal, the third multiplexed signal comprising a fourth stream of digitized audio data generated by a fourth audio peripheral coupled to the secondary device; and
at the third I2S interface circuit, extracting the third stream of digitized audio data and the fourth stream of digitized audio data from the merged multiplexed signal.

9. The method of claim 8, wherein merging the second multiplexed signal with the third multiplexed signal comprises using the third I2S interface circuit to:
interleave serialized words of the third stream of digitized audio data with serialized words of the fourth stream of digitized audio data.

10. The method of claim 8, wherein the third audio peripheral and the fourth audio peripheral include analog-to-digital converters configured to produce digitized audio data from analog signals.

11. The method of claim 8, further comprising:
using a sample rate converter to modify a sampling rate associated with the third stream of digitized audio data extracted from the merged multiplexed signal or the fourth stream of digitized audio data extracted from the merged multiplexed signal.

12. The method of claim 8, further comprising:
using a sample rate converter to modify a sampling rate associated with a stream of digitized audio data provided to the third audio peripheral or the fourth audio peripheral.

13. An apparatus, comprising:
a first device coupled to an Inter-IC Sound (I2S) bus, the first device including a first I2S interface coupled to a plurality of wires of an I2S bus,
a second device coupled to the I2S bus, the second device including a second I2S interface,
wherein the first I2S interface is configured to:
time-division multiplex a first stream of digitized audio data with a second stream of digitized audio data to obtain a first multiplexed signal;
transmit the first multiplexed signal over the I2S bus to the second device;
receive a feedback signal representative of the first multiplexed signal;
extract the first stream of digitized audio data from the feedback signal; and
provide the first stream of digitized audio data extracted from the feedback signal to a second audio peripheral coupled to the primary device,
wherein the second I2S interface is configured to:
extract the second stream of digitized audio data from the first multiplexed signal and provide the second stream of digitized audio data to a first audio peripheral coupled to the second device, and
wherein the first audio peripheral and the second audio peripheral include digital-to-analog converters configured to produce analog signals from respective digitized audio data.

14. The apparatus of claim 13, wherein the first I2S interface is configured to:
serialize the first stream of digitized audio data;
serialize the second stream of digitized audio data; and
interleave serialized words of the first stream of digitized audio data with serialized words of the second stream of digitized audio data to obtain the first multiplexed signal.

15. The apparatus of claim 14, wherein the first I2S interface is configured to:
de-interleave serialized data corresponding to the first stream of digitized audio data from the feedback signal; and
de-serialize the serialized data corresponding to the first stream of digitized audio data.

16. The apparatus of claim 14, further comprising:
a sample rate converter coupled to the first I2S interface and configured to provide the first stream of digitized audio data provided to the first I2S interface or the second stream of digitized audio data provided to the first I2S interface,
wherein the sample rate converter is configured to modify a sample rate of one or more source audio signals.

17. The apparatus of claim 13, further comprising:
a sample rate converter coupled to the first I2S interface and configured to modify a sampling rate associated with a stream of digitized audio data provided to the first audio peripheral or the second audio peripheral.

18. (canceled)

19. The apparatus of claim 13, wherein the first device includes a third I2S interface configured to:
time-division multiplex a third stream of digitized audio data generated by a third audio peripheral coupled to the primary device to provide a second multiplexed signal;
merge the second multiplexed signal with a third multiplexed signal received from the I2S bus to obtain a merged multiplexed signal, the third multiplexed signal comprising a fourth stream of digitized audio data generated by a fourth audio peripheral coupled to the second device; and
extract the third stream of digitized audio data and the fourth stream of digitized audio data from the merged multiplexed signal.

20. The apparatus of claim 19, wherein the third I2S interface configured to:
interleave serialized words of the third stream of digitized audio data with serialized words of the fourth stream of digitized audio data to obtain the merged multiplexed signal.

21. The apparatus of claim 19, wherein the third audio peripheral and the fourth audio peripheral include analog-to-digital converters configured to produce digitized audio data from analog signals.

22. The apparatus of claim 19, further comprising:
a sample rate converter configured to provide the third stream of digitized audio data to the second I2S interface,
wherein the sample rate converter is configured to modify a sample rate of one or more source audio signals.

23-26. (canceled)

27. A non-transitory processor-readable medium storing processor-executable code, comprising code for causing a processor to:
cause a primary device to time-division multiplex a first stream of digitized audio data with a second stream of digitized audio data to obtain a first multiplexed signal;
transmit the first multiplexed signal over a serial bus to a secondary device that is configured to extract the first stream of digitized audio data from the first multiplexed signal and provide the first stream of digitized audio data to a first audio peripheral coupled to the secondary device;
cause the primary device to extract the second stream of digitized audio data from the first multiplexed signal; and
provide the second stream of digitized audio data extracted from the first multiplexed signal to a second audio peripheral coupled to the primary device,
wherein the first audio peripheral and the second audio peripheral include digital-to-analog converters configured to produce analog signals from respective digitized audio data.

28. The processor-readable medium of claim 27, and comprising code for causing a processor to:
serialize the first stream of digitized audio data;
serialize the second stream of digitized audio data; and
interleave serialized words of the first stream of digitized audio data with serialized words of the second stream of digitized audio data.

29. The processor-readable medium of claim 28, and comprising code for causing a processor to:
provide a feedback signal representative of the first multiplexed signal; and
cause the primary device to:
de-interleave serialized data corresponding to the second stream of digitized audio data from the feedback signal; and
de-serialize the serialized data corresponding to the second stream of digitized audio data.

30. The processor-readable medium of claim 27, and comprising code for causing a processor to:
cause the primary device to provide a second multiplexed signal by time-division multiplexing a third stream of digitized audio data generated by a third audio peripheral coupled to the primary device;
merge the second multiplexed signal with a third multiplexed signal received from the serial bus to obtain a merged multiplexed signal, the third multiplexed signal comprising a fourth stream of digitized audio data generated by a fourth audio peripheral coupled to the secondary device; and
cause the primary device to extract the third stream of digitized audio data and the fourth stream of digitized audio data from the merged multiplexed signal.

31. The processor-readable medium of claim 27, and comprising code for causing a processor to:
using a sample rate converter to modify a sampling rate associated with digitized audio data provided to the first audio peripheral or the second audio peripheral.

32. The method of claim 4, wherein the first audio peripheral and the second audio peripheral include digital-to-analog converters configured to produce analog signals from respective digitized audio data.

33. The method of claim 4, further comprising:
using a sample rate converter to modify a sampling rate associated with digitized audio data provided to the first audio peripheral or the second audio peripheral.
